(19) United States
(12) Patent Application Publication
(10) Pub. No.: US 2019/0296427 A1
(43) Pub. Date: Sep. 26, 2019

(54) ANTENNA DEVICE

(71) Applicants: AutoNetworks Technologies, Ltd., Yokkaichi, Mie (JP); Sumitomo Wiring Systems, Ltd., Yokkaichi, Mie (JP); Sumitomo Electric Industries, Ltd., Osaka-Shi (JP)

(72) Inventor: Kazutaka Naitou, Yokkaichi, Mie (JP)

(21) Appl. No.: 16/463,911

(22) PCT Filed: Oct. 12, 2017
(86) PCT No.: PCT/JP2017/036970

§ 371 Date: May 24, 2019

(30) Foreign Application Priority Data
Dec. 1, 2016 (JP) 2016-234272

(51) Int. Cl. H01Q 1/32; H01Q 1/36; H01Q 21/24; H01Q 3/24; H01Q 9/42; H01Q 9/04; H04B 7/10; H04B 1/3822

(52) U.S. Cl. CPC H01Q 1/3275; H01Q 1/36; H01Q 21/24; H04B 1/3822; H01Q 9/42; H01Q 9/0407; H04B 7/10; H01Q 3/24

(57) ABSTRACT

An antenna device includes a plurality of antenna elements mounted to one surface of a substrate, each of the plurality of antenna elements including: a flat plate portion that is shaped as a rectangular flat plate and is disposed to be spaced apart from the one surface of the substrate; and a connection portion that connects one end side of the flat plate portion in a longitudinal direction to the substrate, wherein each of the plurality of antenna elements is disposed along a peripheral edge of the substrate such that the longitudinal direction of the flat plate portion of one antenna element intersects the longitudinal direction of the flat plate portion of at least one other antenna element.

### CROSS-REFERENCE TO RELATED APPLICATIONS

This application is the U.S. national stage of PCT/JP2017/036970 filed on Oct. 12, 2017, which claims priority of Japanese Patent Application No. JP 2016-234272 filed on Dec. 1, 2016, the contents of which are incorporated herein.

### TECHNICAL

The present disclosure relates to an antenna device.

### BACKGROUND

Conventionally, vehicle communication systems for use in a keyless entry systems, smart entry (registered trademark) systems, and the like have been proposed. In such vehicle communication systems, locking and unlocking of vehicle doors are performed by wireless communication conducted between portable devices carried by vehicle occupants and vehicle-mounted control devices that control the locking and unlocking of the vehicle doors.

Each of the portable device and the vehicle-mounted control device includes an antenna device for conducting wireless communication using radio waves. For example, Patent Document 1 discloses, as one antenna device for use in the portable device or the vehicle-mounted control device, an antenna device including a rectangular circuit board, and a flat plate-shaped antenna element that is disposed to be spaced apart from the circuit board and is bent along the outer peripheral edge of the circuit board.

However, a phenomenon in which the reception sensitivity to radio waves is reduced in a specific direction arises in the antenna device disclosed in Patent Document 1. Accordingly, depending on the relative positional relationship between the orientation of the substrate of the antenna device installed in the vehicle and the orientation of the substrate of the antenna device provided in the portable device operated by the vehicle occupant, a significant reduction in reception sensitivity may occur between the two antenna devices, thus resulting in a situation where communication cannot be conducted.

The present disclosure has been made in view of such circumstances, and an object of the disclosure is to provide an antenna device that can prevent a situation where communication cannot be conducted even when the substrate of the antenna device is installed in an arbitrary orientation.

### SUMMARY

An antenna device according to an aspect of the present application includes: a plurality of antenna elements mounted to one surface of a substrate, each of the plurality of antenna elements including: a flat plate portion that is shaped as a rectangular flat plate and is disposed to be spaced apart from the one surface of the substrate; and a connection portion that connects one end side of the flat plate portion in a longitudinal direction to the substrate, wherein each of the plurality of antenna elements is disposed along a peripheral edge of the substrate such that the longitudinal direction of the flat plate portion of one antenna element intersects the longitudinal direction of the flat plate portion of at least one other antenna element.

### Advantageous Effects of Disclosure

According to the present application, it is possible to prevent a situation where communication cannot be conducted even when the substrate of the antenna device is installed in an arbitrary orientation.

### BRIEF DESCRIPTION OF DRAWINGS

FIG. 1 is a schematic diagram illustrating the overall configuration of an antenna device according to Embodiment 1.

FIG. 2 is a schematic diagram illustrating the overall configuration of an antenna device according to a comparative example.

FIG. 3 shows diagrams illustrating antenna characteristics provided when the antenna device of the comparative example is installed in a horizontal orientation.

FIG. 4 shows diagrams illustrating antenna characteristics provided when the antenna device of the comparative example is installed in a vertical longitudinal orientation.

FIG. 5 shows diagrams illustrating antenna characteristics provided when the antenna device of the comparative example is in a vertical transverse orientation.

FIG. 6 shows diagrams illustrating antenna characteristics provided when the antenna device according to Embodiment 1 is installed in a horizontal orientation.

FIG. 7 shows diagrams illustrating antenna characteristics provided when the antenna device according to Embodiment 1 is installed in a vertical longitudinal orientation.

FIG. 8 shows diagrams illustrating antenna characteristics provided when the antenna device according to Embodiment 1 is installed in a vertical transverse orientation.

FIG. 9 is a schematic diagram illustrating the overall configuration of an antenna device according to Embodiment 2.

FIG. 10 shows diagrams illustrating antenna characteristics provided when the antenna device according to Embodiment 2 is installed in a horizontal orientation.

FIG. 11 shows diagrams illustrating antenna characteristics provided when the antenna device according to Embodiment 2 is installed in a vertical longitudinal orientation.

FIG. 12 shows diagrams illustrating antenna characteristics provided when the antenna device according to Embodiment 2 is installed in a vertical transverse orientation.

### DETAILED DESCRIPTION OF PREFERRED EMBODIMENTS

Aspects of the present disclosure will be listed and described. At least some of the aspects described below may be combined as appropriate.

An antenna device according to an aspect of the present application includes: a plurality of antenna elements mounted to one surface of a substrate, each of the plurality of antenna elements including: a flat plate portion that is shaped as a rectangular flat plate and is disposed to be spaced apart from the one surface of the substrate; and a connection portion that connects one end side of the flat plate portion in a longitudinal direction to the substrate, wherein each of the plurality of antenna elements is disposed along a peripheral edge of the substrate such that the longitudinal direction of the flat plate portion of one antenna element intersects the longitudinal direction of the flat plate portion of at least one other antenna element.

In the above-described aspect, even when directivity exists in the radio waves transmitted from the one antenna element, the other antenna element is selectively used if directivity does not exist in the radio waves transmitted from the other antenna element, and, therefore, the transmission strength will not be reduced in a specific direction, thus making it is possible to suppress the reduction in the reception sensitivity due to directivity. Consequently, it is possible to prevent a situation where communication cannot be conducted.

In an antenna device according to an aspect of the present application, each of the plurality of antenna elements includes a supporting portion that supports another end side of the flat plate portion in the longitudinal direction.

In the above-described aspect, the other end side of the flat plate portion in the longitudinal direction is supported by the supporting portion, and, therefore, the stability of the antenna element can be increased. Accordingly, it is possible to stably transmit/receive radio waves even when the antenna device is attached in a location, such as in a vehicle, where vibrations tend to occur.

In an antenna device according to an aspect of the present application, the flat plate portion, the connection portion, and the supporting portion of each of the antenna elements are formed as a single piece.

In the above-described aspect, the flat plate portion, the connection portion, and the supporting portion of each of the antenna elements are formed as a single piece, and it is therefore possible to simplify the manufacturing process, thus reducing the manufacturing cost.

In an antenna device according to an aspect of the present application, each of the antenna elements is mounted to the one surface of the substrate such that a side surface of the flat plate portion and the one surface of the substrate oppose each other.

In the above-described aspect, each of the antenna elements is mounted such that the wide surface of the flat plate portion and the substrate surface are perpendicular to each other, and it is therefore possible to eliminate the need for, for example, bending processing for bending a portion of the antenna element, thus simplifying the manufacturing process.

In an antenna device according to an aspect of the present application, a length of the flat plate portion of the one antenna element in the longitudinal direction is made shorter than a length of the flat plate portion of the other antenna element in the longitudinal direction.

In the above-described aspect, by causing the one antenna element and the other antenna element to have different antenna lengths, it is possible to cause the antenna elements to have mutually different antenna characteristics. Furthermore, by selectively using an antenna element having good antenna characteristics, the transmission strength will not be reduced in a specific direction, for example, and it is therefore possible to suppress the reduction in the reception sensitivity due to directivity.

In the antenna device according to an aspect of the present application, the one antenna element includes a dielectric member.

In the above-described aspect, the antenna characteristics can be improved by controlling the electrical length in the one antenna element.

In the antenna device according to an aspect of the present application, the dielectric member has a dielectric constant that provides a wavelength-shortening effect to the one antenna element.

In the above-described aspect, the antenna characteristics can be improved by providing a wavelength-shortening effect to the one antenna element, and controlling the electrical length in the one antenna element.

In the following, the present disclosure will be described in detail with reference to the drawings illustrating an embodiment thereof.

### Embodiment 1

FIG. 1 is a schematic diagram illustrating the overall configuration of an antenna device according to Embodiment 1. An antenna device 1 according to Embodiment 1 is an antenna device for transmitting/receiving radio waves, for example, when wireless communication is conducted in a vehicle communication system between a vehicle-mounted control device that is mounted in a vehicle and a portable device that is carried by a vehicle occupant. The antenna device 1 is built in the vehicle-mounted control device, for example. Although the following description will be given for the antenna device 1 that is built in the vehicle-mounted control device, the antenna device 1 may be built in the portable device.

The antenna device 1 includes two antenna elements 2 and 3 that are mounted to one surface of a substrate 5. The substrate 5 is a rectangular printed circuit board, and a signal processing circuit 51 including a transmission/reception circuit is mounted to the central portion of the one surface of the substrate 5, and a layered ground conductor (not shown) is mounted to the other surface thereof. The signal processing circuit 51 is connected, for example, to the vehicle-mounted control device via a connector (not shown), and inputs/outputs a control signal intended for the portable device that is output from the vehicle-mounted control device and a control signal intended for the vehicle-mounted control device that is received through the antenna elements 2 and 3. The signal processing circuit 51 has the function of mutually converting a control signal that is input/output through the connector, and a radio signal that is transmitted/received via the antenna elements 2 and 3.

The antenna elements 2 and 3 included in the antenna device 1 are disposed along the peripheral edge of the substrate 5. In the example in FIG. 1, one antenna element 2 is disposed on a shorter side of the substrate 5, and the other antenna element 3 is disposed on a longer side of the substrate 5. When the antenna elements 2 and 3 are to be differentiated from each other in the following description, the antenna element 2 disposed on the shorter side of the substrate 5 is also referred to as a shorter-side antenna element 2, and the antenna element 3 disposed on the longer side of the substrate 5 is also referred to as a longer-side antenna element 3.

The shorter-side antenna element 2 constitutes a monopole-type antenna, and includes a flat plate portion 21 that is shaped as a rectangular flat plate and is disposed to be spaced apart from the one surface of the substrate 5, a connection portion 22 that connects one end side of the flat plate portion 21 in the longitudinal direction to the substrate 5, and a supporting portion 23 that supports the other end side of the flat plate portion 21 in the longitudinal direction. The flat plate portion 21, the connection portion 22, and the supporting portion 23 are made of a metal such as brass (C2600), and are formed as a single piece using a plate material having a thickness of about 5 mm, for example.

The flat plate portion 21 of the shorter-side antenna element 2 has an appropriate length in the longitudinal direction, and a width of about 5 mm in the height direction. The shorter-side antenna element according to the present embodiment is mounted to the one surface of the substrate 5 such that a side surface (the lower surface of the flat plate portion 21 in the example in FIG. 1) of the flat plate portion 21 is spaced apart from the one surface of the substrate 5 by about 10 mm to 15 mm and opposes the one surface of the substrate 5, and the longitudinal direction of the flat plate portion 21 extends along the peripheral edge of the substrate 5 on the shorter side. That is, in the present embodiment, the shorter-side antenna element 2 is mounted to the one surface of the substrate 5 in an orientation in which a wide surface of the flat plate portion 21 and the one surface of the substrate 5 are substantially perpendicular to each other.

The connection portion 22 of the shorter-side antenna element 2 is a flat plate portion 21 that is shaped as a rectangular flat plate and has an upper end that extends continuously with one end side of the flat plate portion 21, and the connection portion 22 connects the one end side of the flat plate portion 21 to the substrate 5. The height of the connection portion 22 from the one surface of the substrate 5 is about 10 mm to 15 mm. The lower end of the connection portion 22 is attached to the one surface of the substrate 5 in an orientation in which the wide surface thereof is substantially orthogonal to the one surface of the substrate 5. The substrate 5 includes a connection-side mounting portion 52a at an attachment location to which the connection portion 22 is attached. The connection-side mounting portion 52a includes, for example, an insertion hole into which the lower end of the connection portion 22 is inserted, and a pattern wire formed at the peripheral edge portion of the insertion hole. The pattern wire included in the connection-side mounting portion 52a is electrically connected to the signal processing circuit 51.

The supporting portion 23 of the shorter-side antenna element 2 is a flat plate member that is shaped as a rectangular flat plate and has an upper end that extends continuously with the other end side of the flat plate portion 21, and the supporting portion 23 supports the other end side of the flat plate portion 21. The supporting portion 23 has the same height as the connection portion 22, and the height is about 10 mm to 15 mm from the one surface of the substrate 5. The lower end of the supporting portion 23 is attached to the one surface of the substrate 5 in an orientation in which the wide surface thereof is substantially orthogonal to the one surface of the substrate 5. The substrate 5 includes an insulation-side mounting portion 52b at an attachment location to which the supporting portion 23 is attached. The insulation-side mounting portion 52b includes, for example, an insertion hole into which the lower end of the supporting portion 23 is inserted, and a pattern wire formed at the peripheral edge portion of the insertion hole. The pattern wire included in the insulation-side mounting portion 52b is electrically insulated from the signal processing circuit 51.

Although the present embodiment adopts a configuration in which the supporting portion 23 is included in order to stably support the flat plate portion 21 of the shorter-side antenna element 2, the supporting portion 23 may not be necessarily included if the flat plate portion 21 can be stably supported by the connection portion 22.

Although the present embodiment adopts a configuration in which the shorter-side antenna element 2 includes the supporting portion 23, it is possible to adopt a configuration in which the supporting portion 23 is included as a separate member. In this case, the supporting portion 23 does not need to be a plate material made of a metal as in the cases of the flat plate portion 21 and the connection portion 22, and may be formed, for example, using an insulating square material made of a resin or the like.

The configuration of the longer-side antenna element 3 is the same as that of the shorter-side antenna element 2. That is, the longer-side antenna element 3 is a monopole-type antenna, and includes a flat plate portion 31 that is shaped as a rectangular flat plate and is disposed to be spaced apart from the one surface of the substrate 5, a connection portion 32 that connects one end side of the flat plate portion 31 in the longitudinal direction to the substrate 5, and a supporting portion 33 that supports the other end side of the flat plate portion 31 in the longitudinal direction. The flat plate portion 31, the connection portion 32, and the supporting portion 33 are made of a metal such as brass (C2600), and are formed as a single piece using a plate material having a thickness of about 5 mm, for example.

The flat plate portion 31 of the longer-side antenna element 3 has an appropriate length in the longitudinal direction, and a width of about 5 mm in the height direction. The longer-side antenna element 3 according to the present embodiment is mounted to the one surface of the substrate 5 such that a side surface (the lower surface of the flat plate portion 31 in the example in FIG. 1) of the flat plate portion 31 is spaced apart from the one surface of the substrate 5 by about 10 mm to 15 mm and opposes the one surface of the substrate 5, and the longitudinal direction of the flat plate portion 31 extends along the peripheral edge of the substrate 5 on the longer side. That is, in the present embodiment, the longer-side antenna element 3 is mounted to the one surface of the substrate 5 in an orientation in which a wide surface of the flat plate portion 31 and the one surface of the substrate 5 are substantially perpendicular to each other.

The connection portion 32 of the longer-side antenna element 3 is a flat plate member that is shaped as a rectangular flat plate and has an upper end that extends continuously with one end side of the flat plate portion 31, and the connection portion 32 connects the one end side of the flat plate portion 31 to the substrate 5. The height of the connection portion 32 from the one surface of the substrate 5 is about 10 mm to 15 mm. The lower end of the connection portion 32 is attached to the one surface of the substrate 5 in an orientation in which the wide surface thereof is substantially orthogonal to the one surface of the substrate 5. The substrate 5 includes a connection-side mounting portion at an attachment location to which the connection portion 32 is attached. The connection-side mounting portion 53a includes, for example, an insertion hole that is provided in proximity to the connection-side mounting portion 52a to which the shorter-side antenna element 2 is mounted, and into which the lower end of the connection portion 32 is inserted, and a pattern wire formed at the peripheral edge portion of the insertion hole. The pattern wire included in the connection-side mounting portion 53a is electrically connected to the signal processing circuit 51.

The supporting portion 33 of the longer-side antenna element 3 is a flat plate member that is shaped as a rectangular flat plate and has an upper end that extends continuously with the other end side of the flat plate portion 31, and the supporting portion 33 supports the other end side of the flat plate portion 31.

The supporting portion 33 has the same height as the connection portion 32, and the height is about 10 mm to 15 mm from the one surface of the substrate 5. The lower end of the supporting portion 33 is attached to the one surface of the substrate 5 in an orientation in which the wide surface thereof is substantially orthogonal to the one surface of the substrate 5. The substrate 5 includes an insulation-side mounting portion 53b at an attachment location to which the supporting portion 33 is attached. The insulation-side mounting portion 53b includes, for example, an insertion hole into which the lower end of the supporting portion 33 is inserted, and a pattern wire formed at the peripheral edge portion of the insertion hole. The pattern wire included in the insulation-side mounting portion 53b is electrically insulated from the signal processing circuit 51.

Although the present embodiment adopts a configuration in which the supporting portion 33 is included in order to stably support the flat plate portion 31 of the longer-side antenna element 3, the supporting portion 33 may not be necessarily included if the flat plate portion 31 can be stably supported by the connection portion 32.

Although the present embodiment adopts a configuration in which the longer-side antenna element 3 includes the supporting portion 33, it is possible to adopt a configuration in which the supporting portion 33 is included as a separate member. In this case, the supporting portion 33 does not need to be a plate material made of a metal as in the cases of the flat plate portion 31 and the connection portion 32, and may be formed, for example, using an insulating square material made of a resin or the like.

Here, the lengths of the flat plate portions 21 and 31 of the antenna elements 2 and 3 can be designed as appropriate according to the wavelength of the radio waves transmitted/received via the antenna elements 2 and 3. For example, in the case of transmitting/receiving radio waves of the 300-MHz band for use in a vehicle communication system, the lengths are designed such that the sum of length L1 of the shorter-side antenna element 2 in the longitudinal direction and length L2 of the longer-side antenna element 3 in the longitudinal direction (=L1+L2) is about 15 to 24 cm, and that L2 is about 1.5 to 1.7 times L1.

Before describing the characteristics of the antenna device 1 according to Embodiment 1, an antenna device including one antenna element having a shape that is bent along the peripheral edge of the substrate as a comparative example, and the characteristics of the antenna device will be described below.

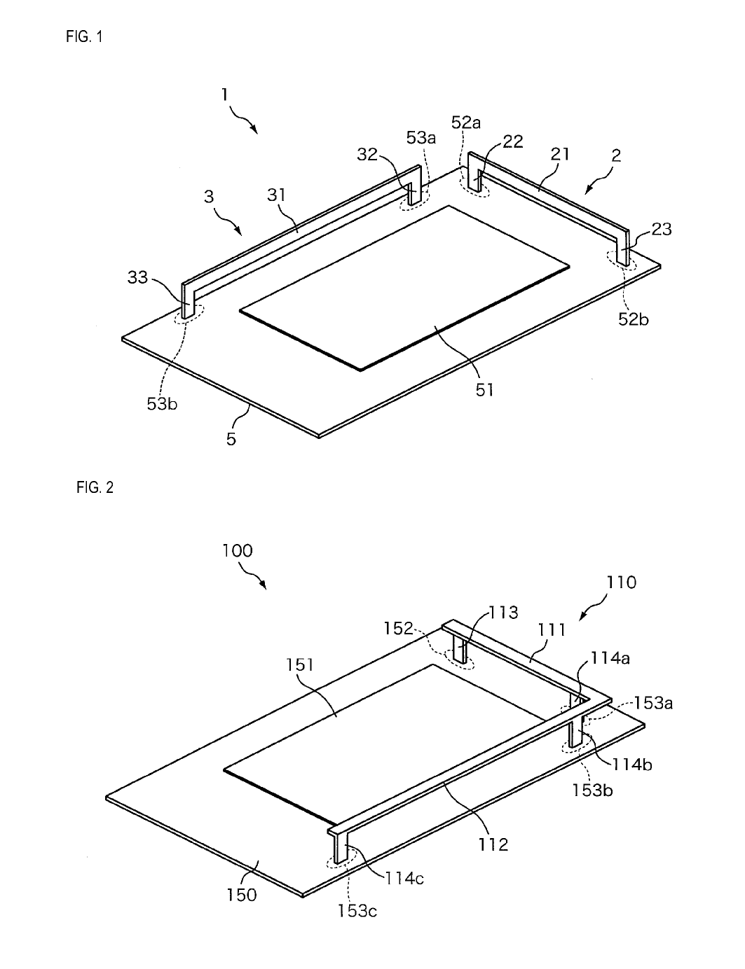

FIG. 2 is a schematic diagram illustrating the overall configuration of an antenna device according to a comparative example. An antenna device 100 according the comparative example includes an antenna element 110 that is mounted to one surface of a substrate 150. The substrate 150 is a rectangular printed circuit board, and a signal processing circuit 151 including a transmission/reception circuit is mounted to the central portion of the one surface of the substrate 150, and a layered ground conductor (not shown) is mounted to the other surface thereof.

The antenna element 110 included in the antenna device 100 is disposed along the peripheral edge of the substrate 150. The antenna element 110 constitutes a monopole-type antenna, and includes flat plate portions 111 and 112 that are shaped as rectangular flat plates and are disposed to be spaced apart from the one surface of the substrate 150, a connection portion 113 that connects one end of the flat plate portion 111 in the longitudinal direction to the substrate 150, and supporting portions 114a to 114c that respectively support the other end of the flat plate portion 111 and both ends of the flat plate portion 112. The flat plate portions 111 and 112, the connection portion 113, and the supporting portions 114a to 114c are made of a metal such as brass, and are formed as a single piece by bending a plate material having a thickness of about 5 mm, for example.

The two flat plate portions 111 and 112 included in the antenna element 110 extend continuously and orthogonal to each other, and one flat plate portion (flat plate portion 111) is disposed along a shorter side of the substrate 150, and the other flat plate portion (flat plate portion 112) is disposed along a longer side of the substrate 150. In the comparative example, the two flat plate portions 111 and 112 are disposed such that their respective wide surfaces oppose the one surface of the substrate 150.

The connection portion 113 connects one end of the flat plate portion 111 to the substrate 150. A connection-side mounting portion 152 is provided in a mounting area between the connection portion 113 of the antenna element 110 and the substrate 150. The connection-side mounting portion 152 includes, for example, an insertion hole into which the lower end of the connection portion 113 is inserted, and a pattern wire formed at the peripheral edge portion of the insertion hole. The pattern wire included in the connection-side mounting portion 152 is electrically connected to the signal processing circuit 151.

The supporting portion 114a supports the other end of the flat plate portion 111. The supporting portions 114b and 114c respectively support the one end and the other end of the flat plate portion 112. Insulation-side mounting portions 153a to 153c are respectively provided in the mounting areas between each of the supporting portions 114a to 114c and the substrate 150. The insulation-side mounting portions 153a to 153c include, for example, insertion holes into which the lower ends of the supporting portions 114a to 114c are respectively inserted, and pattern wires formed at the peripheral edge portions of the respective corresponding insertion holes. The pattern wires included in the insulation-side mounting portions 153a to 153 are electrically insulated from the signal processing circuit 151.

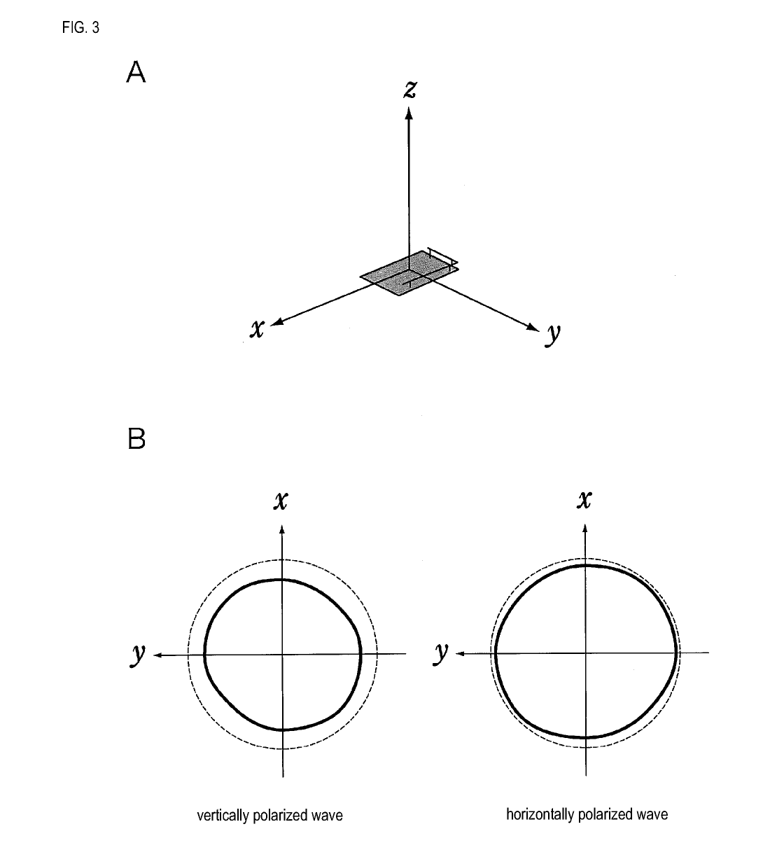

FIG. 3 shows diagrams illustrating antenna characteristics provided when the antenna device 100 of the comparative example is installed in a horizontal orientation. FIG. 3A schematically shows the orientation in which the antenna device 100 is installed. This example shows a state in which the substrate 150 of the antenna device 100 is installed in a horizontal orientation, more specifically, a state in which the substrate 150 is installed such that the longer side thereof is oriented in the x-axis direction, and the shorter side thereof is oriented in the y-axis direction. FIG. 3B shows the directivity (simulation result) of the radio waves transmitted from the antenna device 100 in a state in which the substrate 150 of the antenna device 100 is installed in a horizontal orientation. It can be seen that, when the substrate 150 of the antenna device 100 is installed in a horizontal orientation, the electric field strength of the radio waves transmitted from the antenna device 100 is isotropic in a horizontal plane (in an xy plane) for both a vertically polarized wave and a horizontally polarized wave, and nearly omnidirectional characteristics can be obtained.

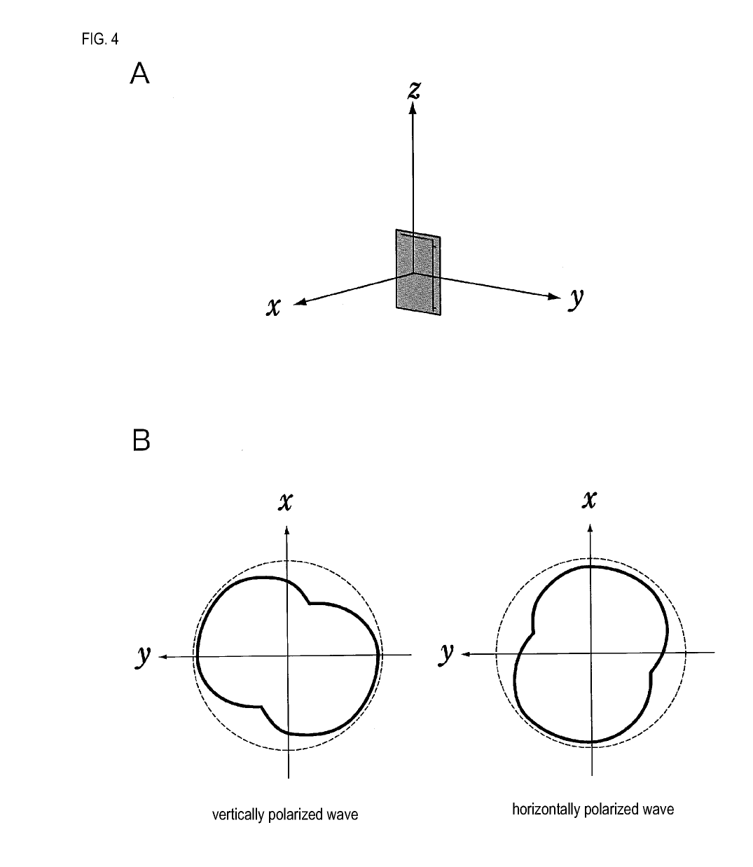

FIG. 4 shows diagrams illustrating antenna characteristics provided when the antenna device 100 of the comparative example is installed in a vertical longitudinal orientation. FIG. 4A schematically shows the orientation in which the antenna device 100 is installed. This example shows a state in which the substrate 150 of the antenna device 100 is installed in a vertical longitudinal orientation, or more specifically, a state in which the substrate 150 is installed such that the longer side thereof is oriented in the z-axis direction, and the shorter side thereof is oriented in the y-axis direction. FIG. 4B shows the directivity (simulation result) of the radio waves transmitted from the antenna device 100 in a state in which the substrate 150 of the antenna device 100 is installed in a vertical longitudinal orientation. It is shown that, when the substrate 150 of the antenna device 100 is installed in a vertical longitudinal orientation, the electric field strength of the radio waves transmitted from the antenna device 100 has a directivity in a horizontal plane (in an xy plane), and the electric field strength is reduced in a direction of 25 degrees and a direction of 205 degrees relative to the x-axis for a vertically polarized wave, and the electric field strength is reduced in a direction of 110 degrees and a direction of 290 degrees relative to the x-axis for a horizontally polarized wave.

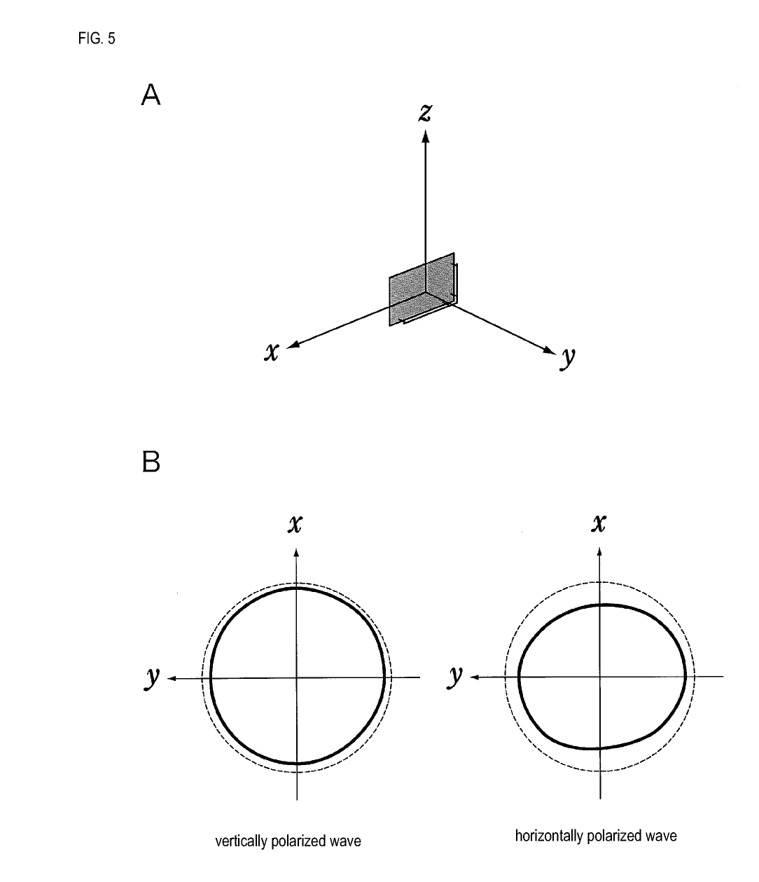

FIG. 5 shows diagrams illustrating antenna characteristics provided when the antenna device 100 of the comparative example is installed in a vertical transverse orientation. FIG. 5A schematically shows the orientation in which the antenna device 100 is installed. This example shows a state in which the substrate 150 of the antenna device 100 is installed in a vertical transverse orientation, more specifically, a state in which the substrate 150 is installed such that the longer side thereof is oriented in the x-axis direction, and the shorter side thereof is oriented in the z-axis direction. FIG. 5B shows the directivity (simulation result) of the radio waves transmitted from the antenna device 100 in a state in which the substrate 150 of the antenna device 100 is installed in a vertical transverse orientation. It can be seen that, when the substrate 150 of the antenna device 100 is installed in a vertical transverse orientation, the electric field strength of the radio waves transmitted from the antenna device 100 is isotropic in a horizontal plane (in an xy plane) for both a vertically polarized wave and a horizontally polarized wave, and nearly omnidirectional characteristics can be obtained.

As described above, for example, when the substrate 150 is installed in a horizontal orientation in the vehicle-mounted control device, and the portable device is carried in a horizontal state, the transmission strength of the radio waves transmitted from the transmission side (the vehicle-mounted control device or the portable device) and the reception strength of the radio waves received by the reception side (the portable device or the vehicle-mounted control device) are reduced in a specific direction for the antenna device 100 according to the comparative example. Accordingly, a sufficient reception strength may not be achieved on the reception side, resulting in the possibility that communication cannot be conducted.

In contrast, the antenna device 1 according to Embodiment 1 includes the shorter-side antenna element 2 and the longer-side antenna element 3, and radio waves are transmitted/received by both the shorter-side antenna element 2 and the longer-side antenna element 3, thus preventing a situation where communication cannot be conducted.

The following describes the antenna characteristics of the antenna device 1 according to Embodiment 1.

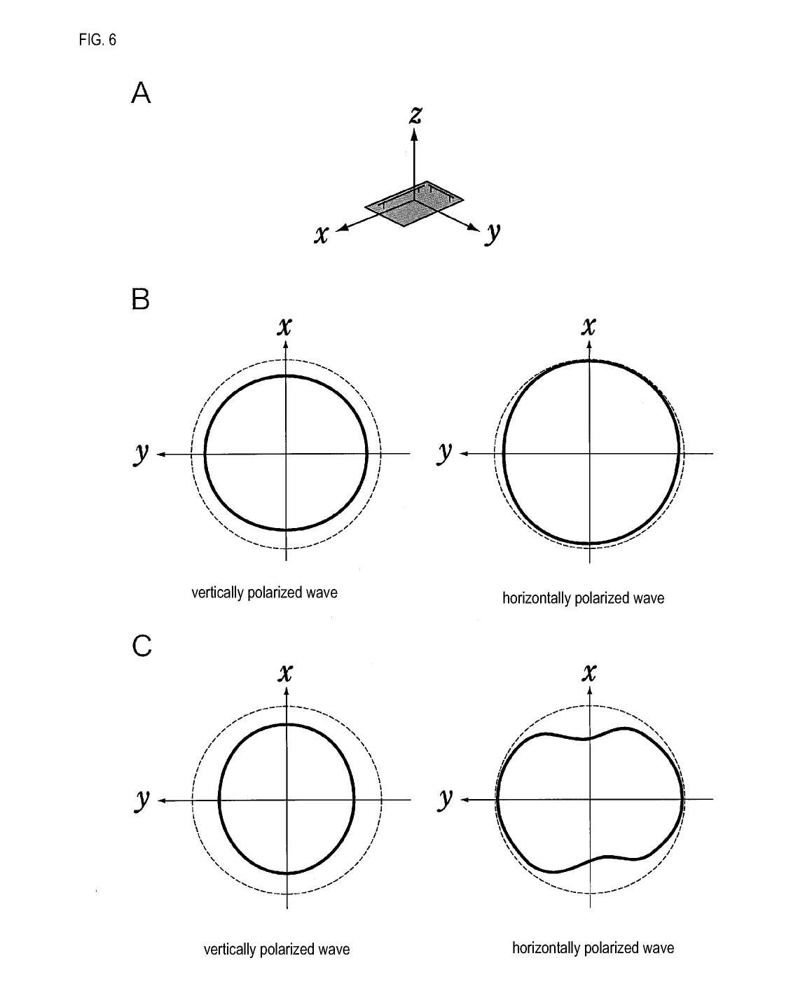

FIG. 6 shows diagrams illustrating antenna characteristics provided when the antenna device 1 according to Embodiment 1 is installed in a horizontal orientation. FIG. 6A schematically shows the orientation in which the antenna device 1 is installed. This example shows a state in which the substrate 5 of the antenna device 1 is installed in a horizontal orientation, more specifically, a state in which the substrate 5 is installed such that the longer side thereof is oriented in the x-axis direction, and the shorter side thereof is oriented in the y-axis direction. FIG. 6B shows the directivity (simulation result) of the radio waves transmitted from the longer-side antenna element 3 in a state in which the substrate 5 of the antenna device 1 is installed in a horizontal orientation. It can be seen that, when the substrate 5 of the antenna device 1 is installed in a horizontal orientation, the electric field strength of the radio waves transmitted from the longer-side antenna element 3 is isotropic in a horizontal plane (in an xy plane) for both a vertically polarized wave and a horizontally polarized wave, and nearly omnidirectional characteristics can be obtained. FIG. 6C shows the directivity (simulation result) of the radio waves transmitted from the shorter-side antenna element 2 in a state in which the substrate 5 of the antenna device 1 is installed in a horizontal orientation. It is shown that, when the substrate 5 of the antenna device 1 is installed in a horizontal orientation, the electric field strength of the radio waves transmitted from the shorter-side antenna element 2 is isotropic for a vertically polarized wave, but has a directivity in a horizontal plane (in an xy plane) for a horizontally polarized wave, and the electric field strength is reduced in a direction of 165 degrees and a direction of 355 degrees relative to the x-axis.

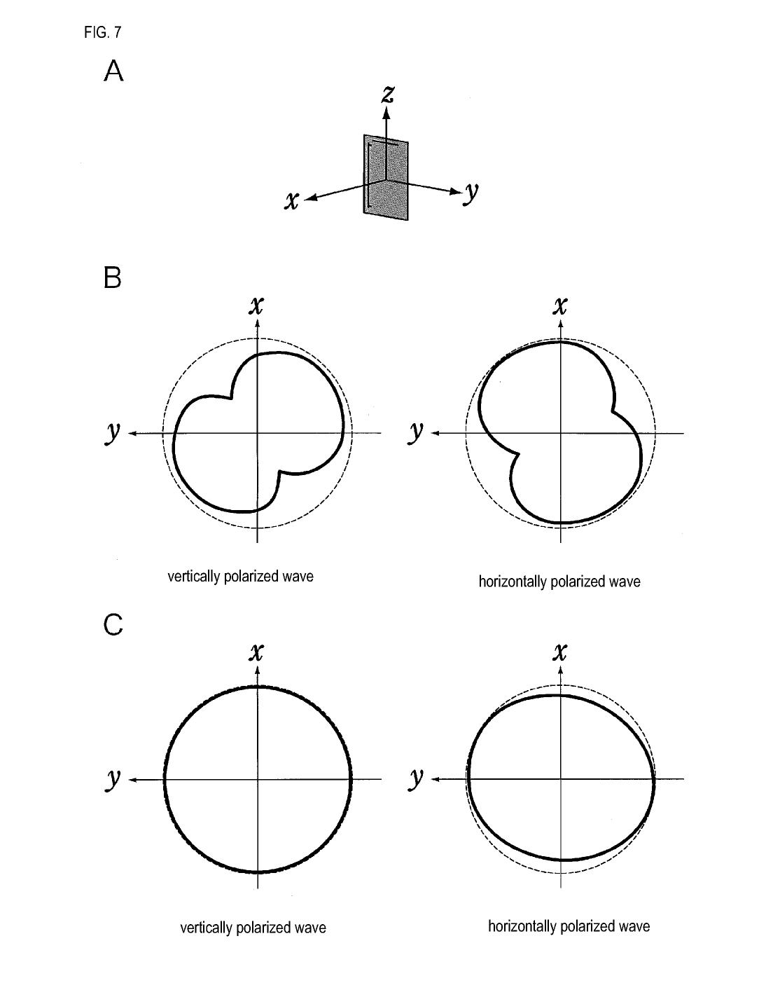

FIG. 7 shows diagrams illustrating antenna characteristics provided when the antenna device 1 according to Embodiment 1 is installed in a vertical longitudinal orientation. FIG. 7A schematically shows the orientation in which the antenna device 1 is installed. This example shows a state in which the substrate 5 of the antenna device 1 is installed in a vertical longitudinal orientation, more specifically, a state in which the substrate 5 is installed such that the longer side thereof is oriented in the z-axis direction, and the shorter side thereof is oriented in the y-axis direction. FIG. 7B shows the directivity (simulation result) of the radio waves transmitted from the longer-side antenna element 3 in a state in which the substrate 5 of the antenna device 1 is installed in a vertical longitudinal orientation. It is shown that, when the substrate 5 of the antenna device 1 is installed in a vertical longitudinal orientation, the electric field strength of the radio waves transmitted from the longer-side antenna element 3 has a directivity in a horizontal plane (in an xy plane), the electric field strength is reduced in a direction of 150 degrees and a direction of 320 degrees relative to the x-axis for a vertically polarized wave, and the electric field strength is reduced in a direction of 70 degrees and a direction of 245 degrees relative to the x-axis for a horizontally polarized wave. FIG. 7C shows the directivity (simulation result) of the radio waves transmitted from the shorter-side antenna element 2 in a state in which the substrate 5 of the antenna device 1 is installed in a vertical longitudinal orientation. It can be seen that, when the substrate 5 of the antenna device 1 is installed in a vertical longitudinal orientation, the electric field strength of the radio waves transmitted from the shorter-side antenna element 2 is isotropic in a horizontal plane (in an xy plane) for both a vertically polarized wave and a horizontally polarized wave, and nearly omnidirectional characteristics can be obtained.

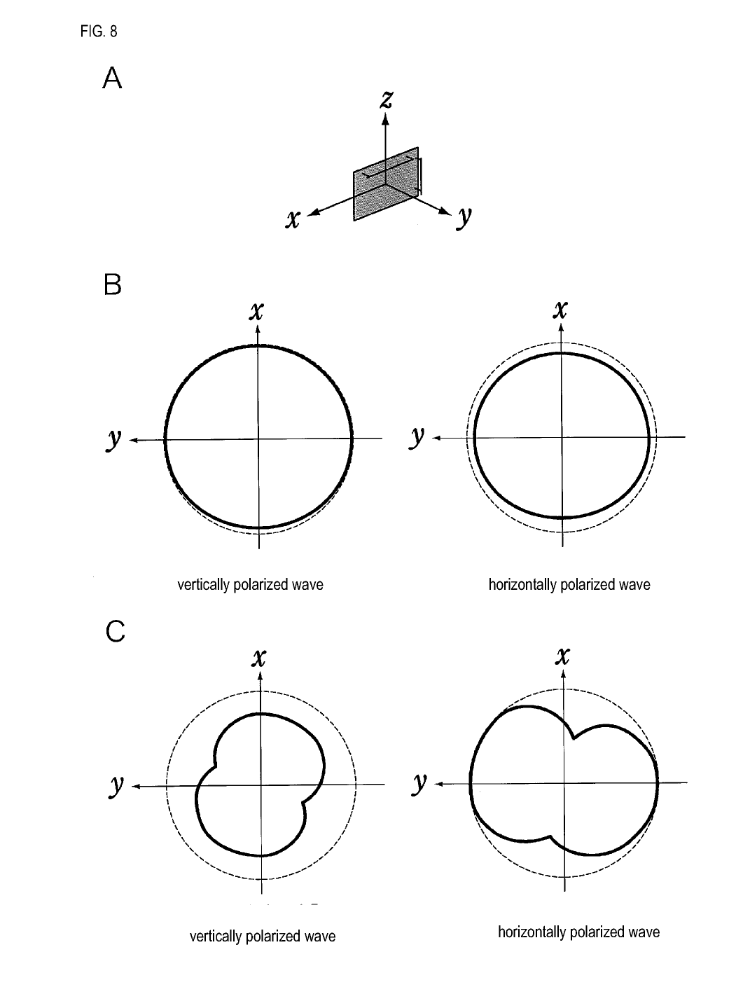

FIG. 8 shows diagrams illustrating antenna characteristics provided when the antenna device 1 according to Embodiment 1 is installed in a vertical transverse orientation. FIG. 8A schematically shows the orientation in which the antenna device 1 is installed. This example shows a state in which the substrate 5 of the antenna device 1 is installed in a vertical transverse orientation, more specifically, a state in which the substrate 5 is installed such that the longer side thereof is oriented in the x-axis direction, and the shorter side thereof is oriented in the z-axis direction. FIG. 8B shows the directivity (simulation result) of the radio waves transmitted from the longer-side antenna element 3 in a state in which the substrate 5 of the antenna device 1 is installed in a vertical transverse orientation. It can be seen that, when the substrate 5 of the antenna device 1 is installed in a vertical transverse orientation, the electric field strength of the radio waves transmitted from the longer-side antenna element 3 is isotropic in a horizontal plane (in an xy plane) for both a vertically polarized wave and a horizontally polarized wave, and nearly omnidirectional characteristics can be obtained. FIG. 8C shows the directivity (simulation result) of the radio waves transmitted from the shorter-side antenna element 2 in a state in which the substrate 5 of the antenna device 1 is installed in a vertical transverse orientation. It is shown that, when the substrate 5 of the antenna device 1 is installed in a vertical transverse orientation, the electric field strength of the radio waves transmitted from the shorter-side antenna element 2 has a directivity in a horizontal plane (in an xy plane), and the electric field strength is reduced in a direction of 110 degrees and a direction of 290 degrees relative to the x-axis for a vertically polarized wave, and the electric field strength is reduced in a direction of 15 degrees and a direction of 195 degrees relative to the x-axis for a horizontally polarized wave.

As described above, with the antenna device 1 according to Embodiment 1, even when a directivity exists in the radio waves transmitted from the shorter-side antenna element 2 (when the substrate 5 is installed in a horizontal orientation, and when the substrate 5 is installed in a vertical transverse orientation), nearly omnidirectional characteristics can be obtained for the radio waves transmitted from the longer-side antenna element 3. Furthermore, even when a directivity exists in the radio waves transmitted from the longer-side antenna element 3 (when the substrate 5 is installed in a vertical longitudinal orientation), nearly omnidirectional characteristics can be obtained for the radio waves transmitted from the shorter-side antenna element 2.

Therefore, the antenna device 1 according to Embodiment 1 selectively uses the shorter-side antenna element 2 and longer-side antenna element 3, and, therefore, the transmission strength will not be reduced in a specific direction on the transmission side and the reception side regardless of the orientation in which the substrate 5 is installed, thus making it possible to suppress the reduction in the reception sensitivity due to directivity. Consequently, it is possible to prevent a situation where communication cannot be conducted.

### Embodiment 2

Embodiment 2 describes a configuration in which the shorter-side antenna element 2 of the antenna device 1 includes a dielectric member 7.

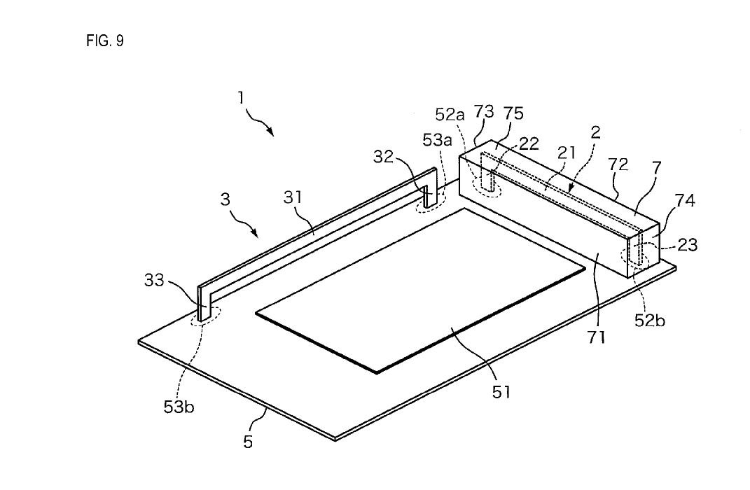

FIG. 9 is a schematic diagram illustrating the overall configuration of an antenna device 1 according to Embodiment 2. An antenna device 1 according to Embodiment 2 includes a shorter-side antenna element 2 and a longer-side antenna element 3 that are mounted to one surface of a substrate 5, and a dielectric member 7 provided for the shorter-side antenna element 2. The configurations of the shorter-side antenna element 2 and the longer-side antenna element 3 are the same as those of Embodiment 1, and the description thereof has been omitted.

The dielectric member 7 is a rectangular solid-shaped casing made of, for example, a dielectric material, and accommodates the shorter-side antenna element 2 therein. The dielectric material that forms the dielectric member 7 has a dielectric constant that provides a wavelength-shortening effect to the shorter-side antenna element 2. The dielectric constant of the dielectric material is 28, for example. In the present embodiment, the dielectric member 7 includes two dielectric substrates 71 and 72 that sandwich a flat plate portion 21 of the shorter-side antenna element 2, and that are disposed respectively opposing one surface and the other surface of the flat plate portion 21, a dielectric substrate 73 that is disposed opposing a side surface of a connection portion 22 on one end side of the flat plate portion 21 in the longitudinal direction, a dielectric substrate 74 that is disposed opposing a side surface of a supporting portion 23 on the other end side of the flat plate portion 21 in the longitudinal direction, and a dielectric substrate 75 that covers the top of the shorter-side antenna element 2.

The following describes the antenna characteristics of the antenna device 1 according to Embodiment 2.

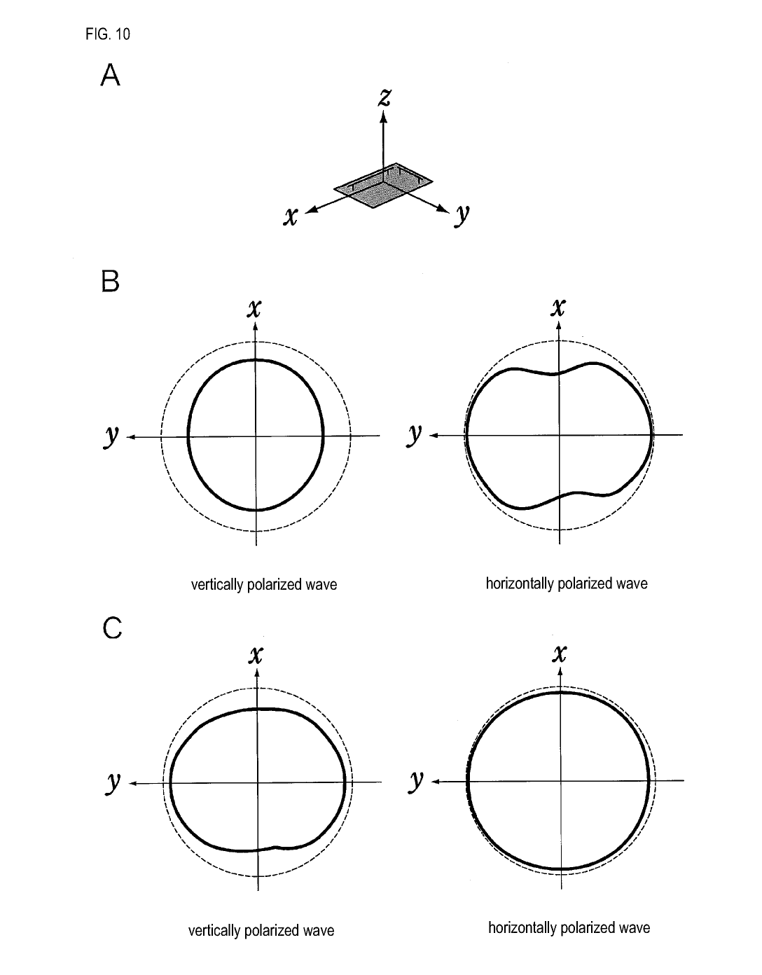

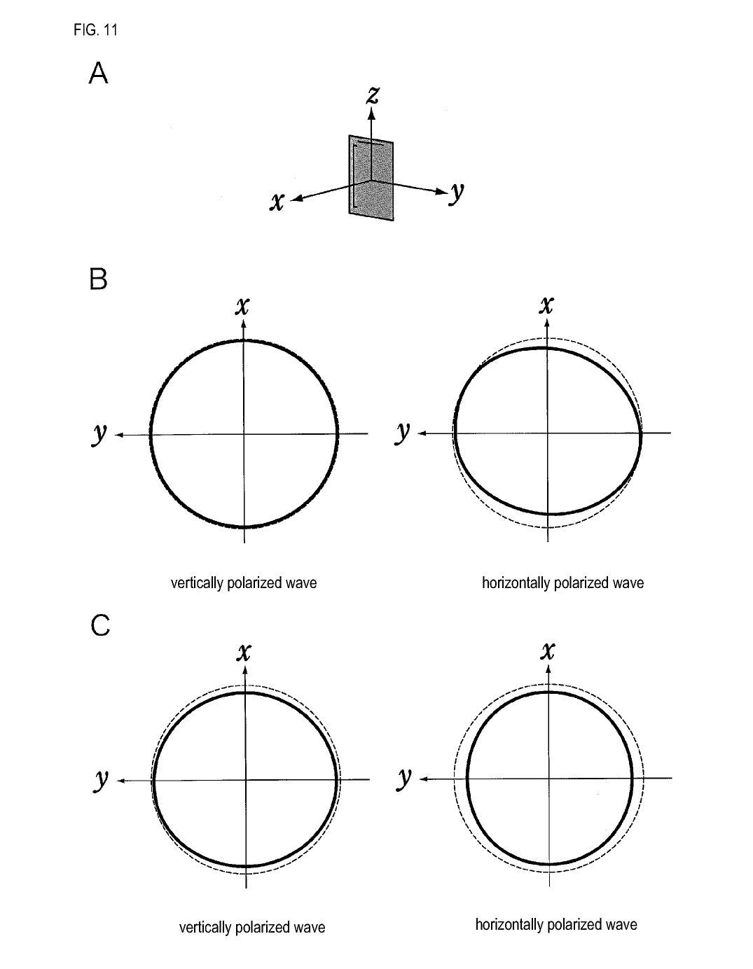

FIG. 10 shows diagrams illustrating antenna characteristics provided when the antenna device 1 according to Embodiment 2 is installed in a horizontal orientation. FIG. 10A schematically shows the orientation in which the antenna device 1 is installed. This example shows a state in which the substrate 5 of the antenna device 1 is installed in a horizontal orientation, more specifically, a state in which the substrate 5 is installed such that the longer side thereof is oriented in the x-axis direction, and the shorter side thereof is oriented in the y-axis direction. FIG. 10B shows the directivity (simulation result) of the radio waves transmitted from a shorter-side antenna element 2 that does not include the dielectric member 7, for comparison. It is shown that, when the dielectric member 7 is not included, the electric field strength of the radio waves transmitted from the shorter-side antenna element 2 is isotropic for a vertically polarized wave, but has a directivity in a horizontal plane (in an xy plane) for a horizontally polarized wave, and the electric field strength is reduced in a direction of 165 degrees and a direction of 355 degrees relative to the x-axis, as described in Embodiment 1. FIG. 10C shows the directivity (simulation result) of the radio waves transmitted from the shorter-side antenna element 2 that includes the dielectric member 7. When the dielectric member 7 is included, an improvement in the directivity is observed for a horizontally polarized wave, and nearly omnidirectional characteristics can be obtained for the radio waves transmitted from the shorter-side antenna element. In addition, it can be seen that the strength of the radio waves is also increased.

FIG. 11 shows diagrams illustrating antenna characteristics provided when the antenna device 1 according to Embodiment 2 is installed in a vertical longitudinal orientation. FIG. 11A schematically shows the orientation in which the antenna device 1 is installed. This example shows a state in which the substrate 5 of the antenna device 1 is installed in a vertical longitudinal orientation, more specifically, a state in which the substrate 5 is installed such that the longer side thereof is oriented in the z-axis direction, and the shorter side thereof is oriented in the y-axis direction. FIG. 11B shows the directivity (simulation result) of the radio waves transmitted from a shorter-side antenna element 2 that does not include the dielectric member 7, for comparison. When the substrate 5 of the antenna device 1 is installed in a vertical longitudinal orientation, even if the dielectric member 7 is not included, the electric field strength of the radio waves transmitted from the shorter-side antenna element 2 is isotropic in a horizontal plane (in an xy plane) for both a vertically polarized wave and a horizontally polarized wave, and nearly omnidirectional characteristics can be obtained. FIG. 11C shows the directivity (simulation result) of the radio waves transmitted from the shorter-side antenna element 2 that includes the dielectric member 7. When the dielectric member 7 is included, the electric field strength of the radio waves transmitted from the shorter-side antenna element 2 is also isotropic, and nearly omnidirectional characteristics can be obtained.

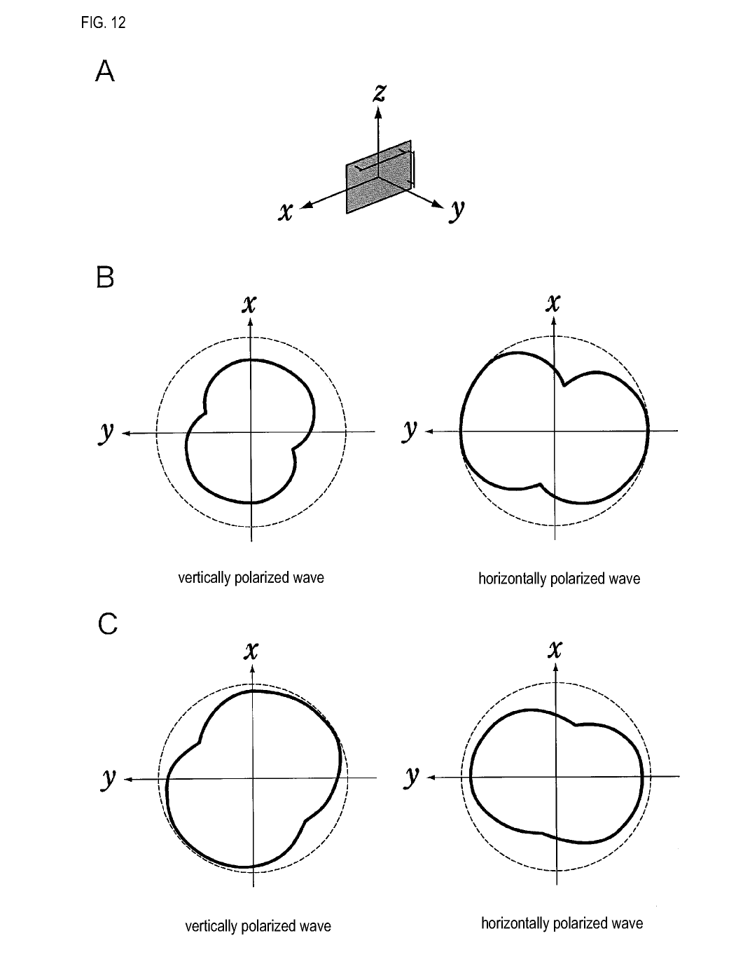

FIG. 12 shows diagrams illustrating antenna characteristics provided when the antenna device 1 according to Embodiment 2 is installed in a vertical transverse orientation. FIG. 12A schematically shows the orientation in which the antenna device 1 is installed. This example shows a state in which the substrate 5 of the antenna device 1 is installed in a vertical transverse orientation, more specifically, a state in which the substrate 5 is installed such that the longer side thereof is oriented in the x-axis direction, and the shorter side thereof is oriented in the z-axis direction. FIG. 12B shows the directivity (simulation result) of the radio waves transmitted from a shorter-side antenna element 2 that does not include the dielectric member 7, for comparison. It is shown that, when the dielectric member 7 is not included, the electric field strength of the radio waves transmitted from the shorter-side antenna element 2 has a directivity in a horizontal plane (in an xy plane), and the electric field strength is reduced in a direction of 110 degrees and a direction of 290 degrees relative to the x-axis for a vertically polarized wave, and the electric field strength is reduced in a direction of 15 degrees and a direction of 195 degrees relative to the x-axis for a horizontally polarized wave, as described in Embodiment 1. FIG. 12C shows the directivity (simulation result) of the radio waves transmitted from the shorter-side antenna element 2 that includes the dielectric member 7. When the dielectric member 7 is included, an improvement in the directivity is observed for both a vertically polarized wave and a horizontally polarized wave.

As described above, in Embodiment 2, providing the dielectric member 7 for the shorter-side antenna element 2 can improve the directivity of the radio waves transmitted from the shorter-side antenna element 2, and suppress the reduction in the reception sensitivity due to directivity. Accordingly, it is possible to prevent a situation where communication cannot be conducted.

Although Embodiments 1 and 2 adopt a configuration in which one shorter-side antenna element 2 and one longer-side antenna element 3 are included, it is possible to adopt a configuration in which two or more shorter-side antenna elements 2 or longer-side antenna elements 3 are included, or a configuration in which two or more shorter side antenna elements 2 and two or more longer-side antenna elements 3 are included.

It should be appreciated that the embodiments disclosed herein are to be construed in all respects as illustrative and not limiting. The scope of the present disclosure is defined by the claims, rather than by the description preceding them, and is intended to include all modifications which fall within the scope of the claims and the meaning and scope of equivalents thereof.

1. An antenna device comprising:
a plurality of antenna elements mounted to one surface of a substrate, each of the plurality of antenna elements including:
a flat plate portion that is shaped as a rectangular flat plate and is disposed to be spaced apart from the one surface of the substrate; and
a connection portion that connects one end side of the flat plate portion in a longitudinal direction to the substrate,
wherein each of the plurality of antenna elements is disposed along a peripheral edge of the substrate such that the longitudinal direction of the flat plate portion of one antenna element intersects the longitudinal direction of the flat plate portion of at least one other antenna element.

2. The antenna device according to claim 1,
wherein each of the plurality of antenna elements includes a supporting portion that supports another end side of the flat plate portion in the longitudinal direction.

3. The antenna device according to claim 2,
wherein the flat plate portion, the connection portion, and the supporting portion of each of the antenna elements are formed as a single piece.

4. The antenna device according to claim 1, wherein each of the antenna elements is mounted to the one surface of the substrate such that a side surface of the flat plate portion and the one surface of the substrate oppose each other.

5. The antenna device according claim 1, wherein a length of the flat plate portion of the one antenna element in the longitudinal direction is made shorter than a length of the flat plate portion of the other antenna element in the longitudinal direction.

6. The antenna device according to claim 5,
wherein the one antenna element includes a dielectric member.

7. The antenna device according to claim 6,
wherein the dielectric member has a dielectric constant that provides a wavelength-shortening effect to the one antenna element.

8. The antenna device according to claim 2, wherein each of the antenna elements is mounted to the one surface of the substrate such that a side surface of the flat plate portion and the one surface of the substrate oppose each other.

9. The antenna device according to claim 3, wherein each of the antenna elements is mounted to the one surface of the substrate such that a side surface of the flat plate portion and the one surface of the substrate oppose each other.

10. The antenna device according claim 2, wherein a length of the flat plate portion of the one antenna element in the longitudinal direction is made shorter than a length of the flat plate portion of the other antenna element in the longitudinal direction.

11. The antenna device according claim 3, wherein a length of the flat plate portion of the one antenna element in the longitudinal direction is made shorter than a length of the flat plate portion of the other antenna element in the longitudinal direction.

12. The antenna device according claim 4, wherein a length of the flat plate portion of the one antenna element in the longitudinal direction is made shorter than a length of the flat plate portion of the other antenna element in the longitudinal direction.
